(19) United States
(12) Patent Application Publication
(10) Pub. No.: US 2018/0149296 A1
(43) Pub. Date: May 31, 2018

(54) PIPE COUPLING SYSTEM AND METHOD

(71) Applicant: David M. McNall, Hinton (CA)

(72) Inventor: David M. McNall, Hinton (CA)

(21) Appl. No.: 15/361,308

(22) Filed: Nov. 25, 2016

(51) Int. Cl. F16L 23/16; F16L 21/00; E03D 11/17

(52) U.S. Cl. CPC F16L 23/16; F16L 2201/40; E03D 11/17; F16L 21/005

(57) ABSTRACT

A one-piece pipe coupling device for commercial water-closets. The pipe coupling consists of a one-piece replacement for a multi-part spud-gasket assembly. The device may be used to couple a toilet bowl fixture and supply pipe of an exposed flush valve. The device is constructed from a single-part resilient body including an internal passage extending between a first end and a second end of the resilient body, the internal passage configured to receive an end portion of the water supply pipe and form a water-tight seal by compressive engagement therewith.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of plumbing seal structures and more specifically relates to pipe couplings for water-closets.

### 2. DESCRIPTION OF RELATED ART

Many public restrooms are equipped with toilet bowl fixtures (water-closets) having exposed flush valves. Such flush valves, also commonly referred to as flushometers, use water from a pressurized water supply rather than gravity from a raised tank to flush the fixture. Most flush valves of this type have a water supply tube that extends downward from the valve body to a multipart spud assembly adapted to couple the supply tube to an inlet port of the water-closet fixture.

A conventional plumbing spud assembly may contain as many as ten separate parts. The inherent complexity of the assembly makes replacement both time consuming and costly. Furthermore, each gasket of the assembly is potential point of failure. A need clearly exists for new systems to overcome the above-mentioned problem, such systems including devices and methods that are more convenient, reliable, and inexpensive than those currently in use.

Several attempts have been made to solve the above-mentioned problems such as those found in Canadian Pat. No. 1263501 to Grimstad. Grimstad discloses a one piece gasket for a toilet which eliminates the use of separate sealing washers and spacing devices. The one piece gasket is formed with flange portions extending from a central sealing portion and has upstanding connectors (with fastener through bores) extending from the flange portions. The connectors can have an enlarged washer head and a bumper element. The washer heads provide an expansion fit into tank fastener holes for preliminary positioning of the gasket. In a preferred manner, the washer heads are of a frustoconical configuration. This art is representative of plumbing seal structures; however, the apparatus of Grimstad utilizes multiple parts and cannot be installed without the use tools. Moreover, none of the known prior art, taken either singly or in combination, is seen to describe the system as claimed.

### BRIEF SUMMARY OF THE INVENTION

In view of the foregoing disadvantages inherent in the known plumbing art, the present invention provides a novel pipe coupling for water-closets. The general purpose of the present invention, which will be described subsequently in greater detail is to provide a one-piece replacement for a spud-gasket assembly, which may be used to operably couple a toilet bowl fixture and supply pipe of an exposed flush valve.

A pipe coupling system for a toilet bowl fixture is disclosed herein. In a preferred embodiment of the system, a single-part resilient body is provided. The single-part resilient body is configured to be removably engaged within a water inlet opening located within a fixture wall of the toilet bowl fixture. The single-part resilient body includes an internal passage extending between a first end and a second end of the resilient body. The internal passage is configured to receive an end portion of a water supply pipe and form a water-tight seal by compressive engagement therewith. A first enlarged flange portion circumferentially surrounds the first end. The first enlarged flange portion is configured to pass through the water inlet opening and form a water-tight seal with an inner surface of the fixture wall around the water inlet opening.

A second enlarged flange portion circumferentially surrounds the second end. The second enlarged flange portion is configured to form a water-tight seal with an outer surface of the fixture wall around the water inlet opening. Disposed between the first enlarged flange portion and the second enlarged flange portion is a recessed annular groove configured to engage an inner periphery of the water inlet opening when the single-part resilient body is positioned within the fixture wall.

The single-part resilient body is formed from an elastomeric material that is deformable under compression. In one embodiment of the present system, the elastomeric material comprises a Durometer shore A hardness of between about 40 and about 90. In one embodiment of the present system, the single-part resilient body is formed from a molded synthetic rubber.

The single-part resilient body may further comprise a longitudinal axis extending between the first end and a second end. In one embodiment of the present system the internal passage, the first enlarged flange portion, and the second enlarged flange portion are arranged symmetrically about the longitudinal axis.

In one embodiment of the present system the first enlarged flange portion further comprises a generally frustoconical shape of circular right section arranged symmetrically with respect to the longitudinal axis. Furthermore, the second enlarged flange portion also comprises a generally frustoconical shape of circular right section arranged symmetrically with respect to the longitudinal axis. In addition, second enlarged flange portion includes a base portion located adjacent the recessed annular groove and concentric with the longitudinal axis and a sidewall projecting outward from the base portion and tapering to a distal circumferential edge concentric with the longitudinal axis. In one embodiment of the present system the distal circumferential edge has a smoothly rounded geometry.

The first enlarged flange portion is configured to resiliently deform during passage through the water inlet opening and restore to a pre-deformed geometry to engage the inner surface of the fixture wall after such passage. Moreover, the water supply pipe is retained within the internal passage by friction fit. In one embodiment of the present system, the internal passage comprises a cylindrical bore adapted to receive a water supply pipe having an outer diameter between about ¾ inch and about 2 inches.

The water-tight seals of the one-piece pipe coupling device are formed by elastomeric compression at the mating surfaces. The pipe coupling device can be installed in toilet bowl fixture without the use of tools and can be removed from the toilet bowl fixture without the use of tools. Additionally, it provides such a toilet fixture system further comprising set of instructions; and wherein the device is arranged as a kit. According to another embodiment of the present system, the toilet bowl fixture is provided with the kit. The present invention can also be used with a urinal.

According to another embodiment, a toilet fixture pipe-coupling method is also disclosed herein. The method for providing the toilet fixture pipe-coupling includes the steps of: identifying a commercially-available toilet bowl fixture, the toilet bowl fixture having a fixture wall containing a water inlet opening; measuring the physical geometry of the fixture wall and the water inlet opening; using the measured physical geometry of the fixture wall and the water inlet opening to produce a pipe coupling device to removably engage the water inlet opening; the pipe coupling device comprising a single-part resilient body including an internal passage extending between a first end and a second end of the resilient body, the internal passage configured to receive an end portion of a water supply pipe and form a water-tight seal by compressive engagement therewith, a first enlarged flange portion circumferentially surrounding the first end, the first enlarged flange portion configured to pass through the water inlet opening and form a water-tight seal with an inner surface of the fixture wall around the water inlet opening, a second enlarged flange portion circumferentially surrounding the second end, the second enlarged flange portion configured to form a water-tight seal with an outer surface of the fixture wall around the water inlet opening, and disposed between the first enlarged flange portion and the second enlarged flange portion, a recessed annular groove configured to engage an inner periphery of the water inlet opening when the single-part resilient body is positioned within the fixture wall; and installing the pipe coupling device within the water inlet opening. Additionally, it provides such a method further comprising the steps of producing an additional stock of pipe coupling devices; and offering the additional stock of pipe coupling devices for commercial sale as replacement parts.

The present pipe coupling system holds significant improvements over the known prior art. Preferably, a pipe coupling system should provide apparatus and arrangements that are more convenient, reliable, and inexpensive than those currently in use. Thus, a need exists for a reliable pipe coupling system to avoid the above-mentioned problems.

For purposes of summarizing the system, certain aspects, advantages, and novel features of the system have been described herein. It is to be understood that not necessarily all such advantages may be achieved in accordance with any one particular embodiment of the system. Thus, the system may be embodied or carried out in a manner that achieves or optimizes one advantage or group of advantages as taught herein without necessarily achieving other advantages as may be taught or suggested herein. The features of the system which are believed to be novel are particularly pointed out and distinctly claimed in the concluding portion of the specification. These and other features, aspects, and advantages of the present system will become better understood with reference to the following drawings and detailed description.

### BRIEF DESCRIPTION OF THE DRAWINGS

The figures which accompany the written portion of this specification illustrate embodiments and method(s) of use for the present disclosure, a pipe coupling system, constructed and operative according to the teachings of the present disclosure.

FIG. 1 shows a side view illustrating a pipe coupling device of the pipe coupling system during an ‘in-use’ condition according to an embodiment of the disclosure.

FIG. 2 is a perspective view, illustrating a single-part resilient body of the pipe coupling device, according to the embodiment of FIG. 1.

FIG. 3 is an exploded perspective view, illustrating the pipe coupling device prior to installation in a toilet bowl fixture, according to the embodiment of FIG. 1.

FIG. 4 is a perspective view, illustrating the pipe coupling device installed in the toilet bowl fixture, according to the embodiment of FIG. 1.

FIG. 5 is a top view, illustrating the pipe coupling device, according to the embodiment of FIG. 1.

FIG. 6 is a side view, illustrating the pipe coupling device, according to the embodiment of FIG. 1.

FIG. 7 is a sectional view, through the section 7-7 of FIG. 5, according to the embodiment of FIG. 1.

FIG. 8 is a sectional diagram, through the toilet bowl fixture, according to the ‘in-use’ condition of FIG. 1.

FIG. 9 is the partial enlarged section view of FIG. 8, illustrating the pipe coupling device engaged within the toilet bowl fixture, according to the ‘in-use’ condition of FIG. 1.

FIG. 10 is a flow diagram illustrating a method of use for the pipe coupling device according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pipe coupling system and more particularly to a pipe coupling for water-closets as used to improve the connection between a toilet bowl fixture and supply pipe of an exposed flush valve.

Generally speaking, the pipe coupling system of the present disclosure provides a one-piece replacement for a standard spud-gasket plumbing assembly, as commonly found at the rear water supply inlet of commercial and public toilet fixtures. The pipe coupling device of the present system is an easy-to-use a one-piece unit that can be installed without the use of tools.

At the rear of most public toilet fixtures (water-closets) is an elaborate pipe coupling assembly used to connect the toilet fixture to a water supply tube that extends downward from the valve body of an exposed flush valve. Such customary pipe coupling assemblies, also referred to as “spud” assemblies, may contain up to ten separate parts, including a series of unreliable gaskets. Such customary “spud-type” plumbing devices are very complex to install, generally requiring several tools to implement a repair. Furthermore, these existing assemblies are expensive and are particularly unreliable with a low in-service life if installed incorrectly.

The present system fully replaces the above-noted multi-part spud assembly with a single grommet-style part that requires no tools to install. The pipe coupling device of the present system provides a one-way snap-into-place installation utilizing no tools. Furthermore, the cost of the device is substantially lower than the conventional “spud-type” plumbing devices.

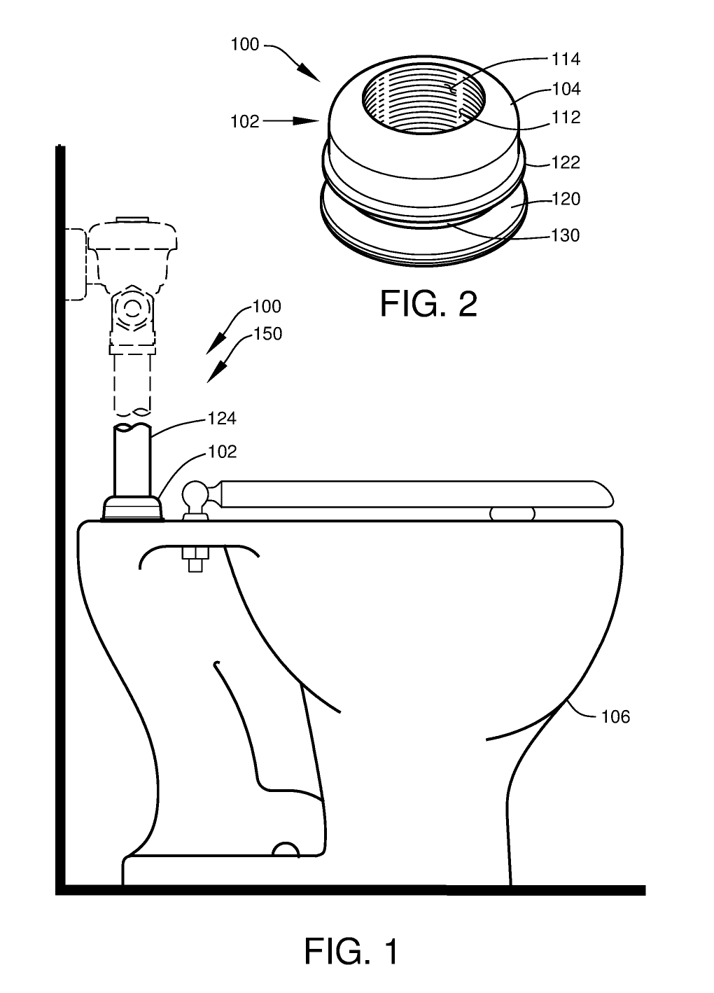

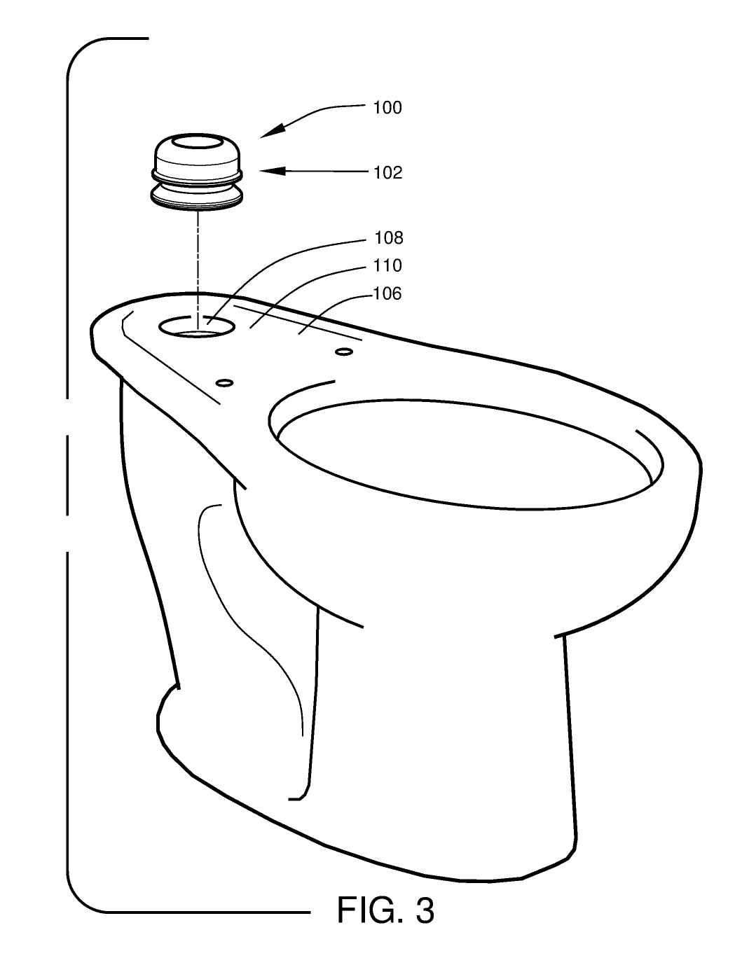

Referring now more specifically to the drawings by numerals of reference, there is shown in FIGS. 1-10, various views of the pipe coupling system 100. FIG. 1 shows a pipe coupling device 102 of the pipe coupling system 100 during an ‘in-use’ condition 150 according to an embodiment of the disclosure. FIG. 2 is a perspective view, illustrating the pipe coupling device 102. FIG. 3 is an exploded perspective view, illustrating the pipe coupling device 102 prior to installation in a toilet bowl fixture 106, according to the embodiment of FIG. 1.

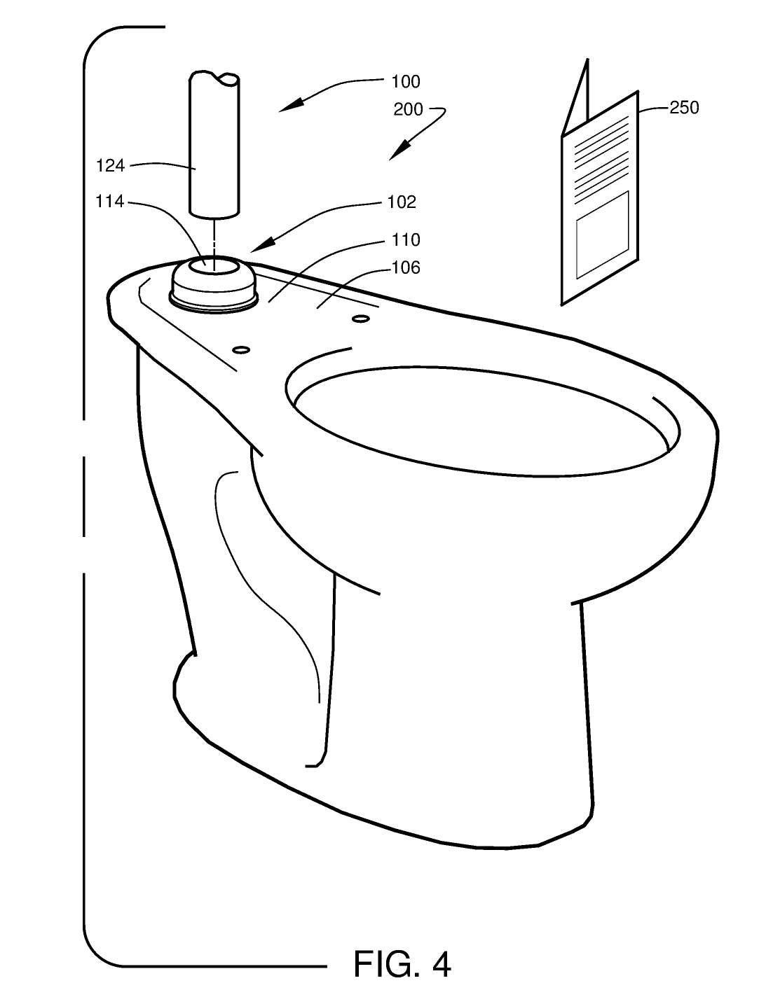

As shown in FIG. 2, the pipe coupling device 102 is a single-part resilient body 104. As shown in FIG. 3, the pipe coupling device 102 is configured to be removably engaged within a water inlet opening 108 located within a rear fixture wall 110 of the toilet bowl fixture 106, as shown. FIG. 4 is a perspective view, illustrating the pipe coupling device 102 installed in the toilet bowl fixture 106, according to the embodiment of FIG. 1. The pipe coupling device 102 utilizes a snap-into-place installation requiring no tools. Once installed within the water inlet opening 108, the pipe coupling device 102 may be used to connect a water supply pipe 124 of an exposed flush valve (flushometer) to the toilet bowl fixture 106, as shown in FIG. 1.

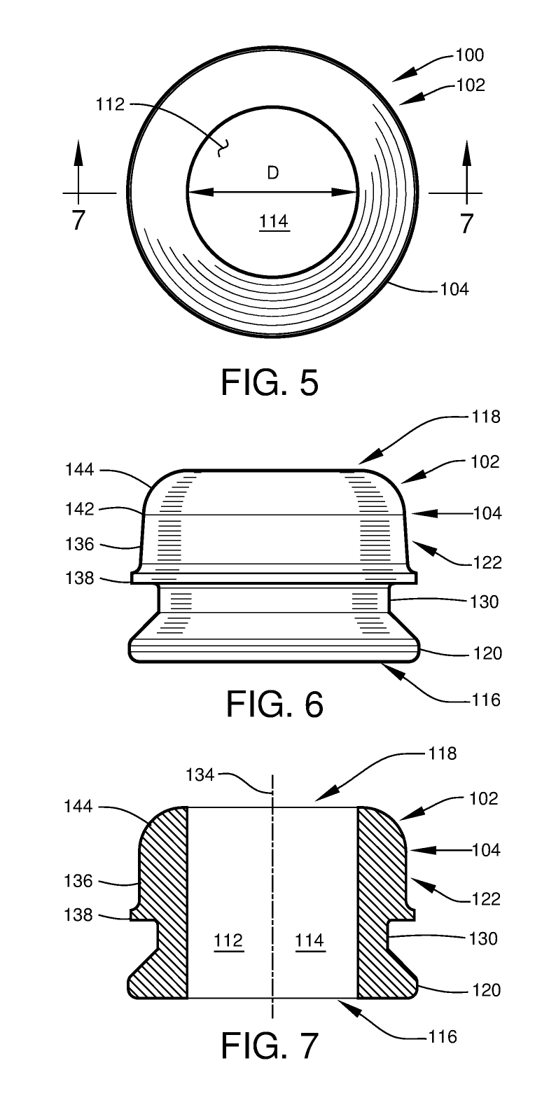

FIG. 5 is a top view, illustrating the pipe coupling device, according to the embodiment of FIG. 1. FIG. 6 is a side view of the pipe coupling device 102. FIG. 7 is a sectional view, through the section 7-7 of FIG. 5 showing the internal features of the pipe coupling device 102 of FIG. 1.

In reference to FIG. 5 through FIG. 7, and with continued reference to the prior drawings, the single-part resilient body 104 includes an internal passage 114 extending between a first end 116 and a second end 118 of the resilient body 104. A first enlarged flange portion 120 circumferentially surrounds the first end 116 with a second enlarged flange portion 122 circumferentially surrounding the second end 118, as shown.

The internal passage 114 is configured to receive an end portion of the water supply pipe 124 and form a water-tight seal by compressive engagement therewith (see also FIG. 9). The first enlarged flange portion 120 is configured to pass through the water inlet opening 108 (see FIG. 3) and form a water-tight seal 126 with an inner surface of the fixture wall 110 surrounding the water inlet opening 108.

Disposed between the first enlarged flange portion 120 and the second enlarged flange portion 122 is a recessed annular groove 130 configured to engage an inner periphery 132 of the water inlet opening 108 when the single-part resilient body 104 is positioned within the fixture wall 110.

The single-part resilient body 104 may further comprise a longitudinal axis 134 extending between the first end 116 and the second end 118. In one embodiment of the present system the internal passage 114, the first enlarged flange portion 120, and the second enlarged flange portion 122 are arranged symmetrically about the longitudinal axis 134, as shown. In one embodiment of the present system the first enlarged flange portion 120 is arranged to form a generally frustoconical shape of circular right section arranged symmetrically with respect to the longitudinal axis 134. The outer sidewall 136 of the second enlarged flange portion 122 may be of variable configuration, as required to fit a particular water closet design. In one embodiment of the present system the second enlarged flange portion 122 comprises either a cylindrical or the depicted generally-frustoconical shape of circular right section arranged symmetrically with respect to the longitudinal axis 134.

In addition, the second enlarged flange portion 122 includes a base portion 138 located adjacent the recessed annular groove 130 and concentric with the longitudinal axis 134, as shown. The outer sidewall 136 projects outward from the base portion 138 and tapers to a distal circumferential edge 142 that is generally concentric with the longitudinal axis 134. In one embodiment of the present system, the distal circumferential edge 142 may have a smoothly rounded geometry 144, as shown. Upon reading this specification, it should be appreciated that, under appropriate circumstances, considering such issues as manufacturer-specific toilet design, variation in wall thicknesses, structural requirements, variations in inlet geometry, technological advances, etc., other shape arrangements such as, for example, other flange shapes, other groove thickness, larger flange diameters, smaller flange diameters, chamfered edges, etc., may be sufficient.

The single-part resilient body 104 may be formed from an elastomeric material that is deformable under compression. In one embodiment of the present system, the elastomeric material comprises a Durometer shore hardness A of between about 40 and about 90. In one embodiment of the present system, the single-part resilient body 104 may be formed from a molded synthetic rubber.

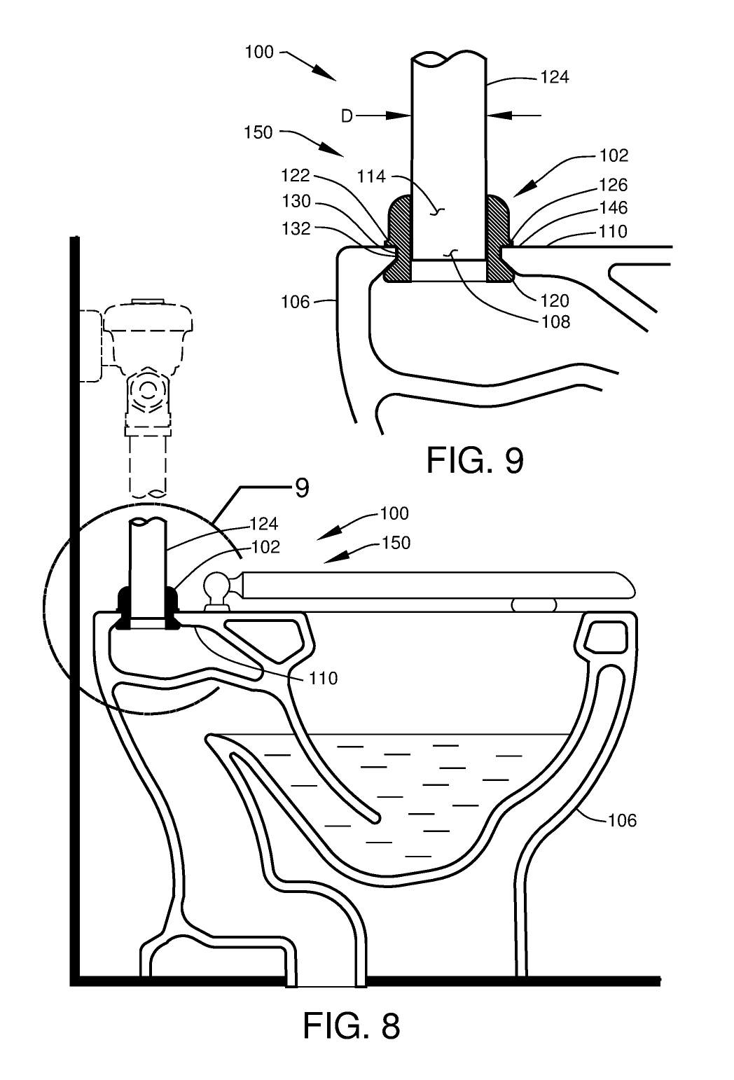

FIG. 8 is a sectional diagram, sectioned through the toilet bowl fixture 106, according to the ‘in-use’ of FIG. 1. FIG. 9 is the partial enlarged section view of FIG. 8, illustrating the pipe coupling device 102 engaged within the toilet bowl fixture 106, according to the ‘in-use’ condition of FIG. 1. The first enlarged flange portion 120 is configured to resiliently deform to allow passage of the flange through the water inlet opening 108 and restore to a pre-deformed geometry to engage the inner surface 128 of the fixture wall 110 after such passage. The second enlarged flange portion 122 is configured to form a water-tight seal 126 with an outer surface 146 of the fixture wall 110 around the water inlet opening 108. More specifically, the enlarged annular base portion 138 forms a water-tight seal 126 outer surface 146.

The sloping contact surface of the first enlarged flange portion 120 provides an annular wall-contacting shape that generally corresponds to the bell-shaped geometry of a conventional spud-type coupling assembly. This shape allows the pipe coupling device 102 to compressively engage the inner periphery 132 of the water inlet opening 108 to form a firm water-tight seal at the fixture opening. It is again noted the pipe coupling device 102 may include alternate flange shapes to accommodate other manufacturer-specific toilet designs.

The water supply pipe 124 is retained within the internal passage 114 by friction fit. In one embodiment of the present system, the internal passage 114 comprises a cylindrical bore 112 having an inner diameter D adapted to receive a standard vacuum-breaking water supply pipe 124 having an outer diameter of between about ¾ inch and about 2 inches. More specifically, the cylindrical bore 112 may have an inner diameter D adapted to receive a water supply pipe 124 having an outer diameter of ¾ inch. Alternately, the cylindrical bore 112 may have an inner diameter D adapted to receive a water supply pipe 124 having an outer diameter of 1¼ inches. In addition, the cylindrical bore 112 may have an inner diameter D adapted to receive a water supply pipe 124 having an outer diameter of 1½ inches. Alternately, the cylindrical bore 112 may have an inner diameter D adapted to receive a water supply pipe 124 having an outer diameter of 2 inches. Upon reading this specification, it should be appreciated that, under appropriate circumstances, considering such issues as country of use, design preference, structural requirements, available pipe sizes, technological advances, etc., other pipe arrangements such as, for example, larger pipe, smaller pipe, pipe of metric sizing, etc., may be sufficient.

The water-tight seals of the one-piece pipe coupling device 102 are formed by elastomeric compression at the mating surfaces. It is again noted that the pipe coupling device 102 can be installed in toilet bowl fixture 106 without the use of tools. Furthermore, it is also possible to remove the device from the toilet bowl fixture 106 without the use of tools by reaching through the central bore and manually extracting the device.

Referring again to FIG. 4, the pipe coupling system 100 may be sold as a kit 200 comprising the following parts: at least one pipe coupling device 102 and at least one set of user instructions 250. The kit has instructions such that functional relationships are detailed in relation to the structure of the invention (such that the invention can be used, maintained, or the like in a preferred manner). According to another embodiment of the present system, the toilet bowl fixture 106 may also be provided with the kit 200. In this alternate embodiment, the pipe coupling device 102 may be pre-installed in the toilet bowl fixture 106.

The pipe coupling system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different finishes or color combinations, parts may be sold separately, etc., may be sufficient.

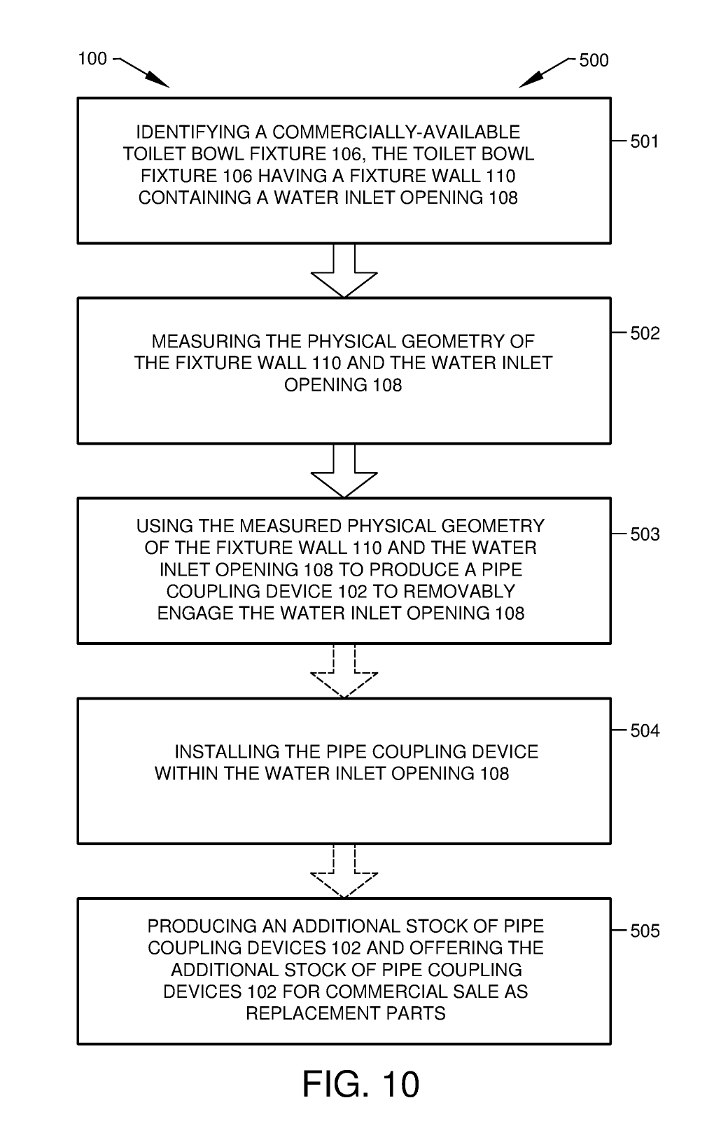

Referring now to FIG. 10 showing a flow diagram, illustrating a method of use 500, according to an embodiment of the pipe coupling system 100. As shown, method of use 500 may comprise the steps of: step one 501, identifying a commercially-available toilet bowl fixture 106, the toilet bowl fixture 106 having a fixture wall 110 containing a water inlet opening 108; step two 502, measuring the physical geometry of the fixture wall 110 and the water inlet opening 108; step three 503, using the measured physical geometry of the fixture wall 110 and the water inlet opening 108 to produce a pipe coupling device 102 to removably engage the water inlet opening 108. In this step, the pipe coupling device 102 is structured and arranged as generally described in FIG. 1 through FIG. 9.

The method of use 500 may further comprise step four 504 installing the pipe coupling device within the water inlet opening 108. The method of use 500 may also comprise step five 505, producing an additional stock of pipe coupling devices 102 and offering the additional stock of pipe coupling devices 102 for commercial sale as replacement parts.

It should be noted that steps 504 and 505 are optional steps and may not be implemented in all cases. Optional steps of method of use 500 are illustrated using dotted lines in FIG. 10 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pipe coupling device relating to the coupling of a water supply pipe to a toilet bowl fixture, the toilet bowl fixture having fixture wall containing a water inlet opening, the pipe coupling device comprising:
a single-part resilient body including
an internal passage extending between a first end and a second end of the resilient body, the internal passage configured to receive an end portion of the water supply pipe and form a water-tight seal by compressive engagement therewith,
a first enlarged flange portion circumferentially surrounding the first end, the first enlarged flange portion configured to pass through the water inlet opening and form a water-tight seal with an inner surface of the fixture wall around the water inlet opening,
a second enlarged flange portion circumferentially surrounding the second end, the second enlarged flange portion configured to form a water-tight seal with an outer surface of the fixture wall around the water inlet opening, and
disposed between the first enlarged flange portion and the second enlarged flange portion, a recessed annular groove configured to engage an inner periphery of the water inlet opening when the single-part resilient body is positioned within the fixture wall.

2. The pipe coupling device of claim 1, wherein the single-part resilient body is formed from an elastomeric material that is deformable under compression.

3. The pipe coupling device of claim 2, wherein the elastomeric material comprises a Durometer shore A hardness of between about 40 and about 90.

4. The pipe coupling device of claim 1, wherein the single-part resilient body is formed from a molded synthetic rubber.

5. The pipe coupling device of claim 1, wherein
the single-part resilient body further comprises a longitudinal axis extending between the first end and a second end, and
the internal passage, the first enlarged flange portion, and the second enlarged flange portion are arranged symmetrically about the longitudinal axis.

6. The pipe coupling device of claim 5, wherein the first enlarged flange portion further comprises a generally frustoconical shape of circular right section arranged symmetrically with respect to the longitudinal axis.

7. The pipe coupling device of claim 5, wherein the second enlarged flange portion comprises
a generally frustoconical shape of circular right section arranged symmetrically with respect to the longitudinal axis,
a base portion located adjacent the recessed annular groove and concentric with the longitudinal axis, and
a sidewall projecting outward from the base portion and tapering to a distal circumferential edge concentric with the longitudinal axis, the distal circumferential edge having a smoothly rounded geometry.

8. The pipe coupling device of claim 1, wherein the first enlarged flange portion is configured to resiliently deform during passage through the water inlet opening and restore to a pre-deformed geometry to engage the inner surface of the fixture wall after such passage.

9. The pipe coupling device of claim 1, wherein the water supply pipe is retained within the internal passage by friction fit.

10. The pipe coupling device of claim 1, wherein the internal passage comprises a cylindrical bore adapted to receive a water supply pipe having an outer diameter of about ¾ inch.

11. The pipe coupling device of claim 1, wherein the internal passage comprises a cylindrical bore adapted to receive a water supply pipe having an outer diameter of about 1¼ inches.

12. The pipe coupling device of claim 1, wherein the internal passage comprises a cylindrical bore adapted to receive a water supply pipe having an outer diameter of about 1½ inches.

13. The pipe coupling device of claim 1, wherein the internal passage comprises a cylindrical bore adapted to receive a water supply pipe having an outer diameter of about 2 inches.

14. The pipe coupling device of claim 1, further comprising a finished flange cover configured to cover the second enlarged flange portion.

15. The pipe coupling device of claim 1, wherein the water-tight seals are formed by elastomeric compression at the mating surfaces.

16. The pipe coupling device of claim 1, wherein
the pipe coupling device can be installed in toilet bowl fixture without the use of tools, and
the pipe coupling device can be removed from the toilet bowl fixture without the use of tools.

17. A toilet fixture system comprising:
a toilet bowl fixture, the toilet bowl fixture having fixture wall containing a water inlet opening,
removably engaged within water inlet opening, a single-part resilient body including
an internal passage extending between a first end and a second end of the resilient body, the internal passage configured to receive an end portion of a water supply pipe and form a water-tight seal by compressive engagement therewith,
a first enlarged flange portion circumferentially surrounding the first end, the first enlarged flange portion configured to pass through the water inlet opening and form a water-tight seal with an inner surface of the fixture wall around the water inlet opening,
a second enlarged flange portion circumferentially surrounding the second end, the second enlarged flange portion configured to form a water-tight seal with an outer surface of the fixture wall around the water inlet opening, and
disposed between the first enlarged flange portion and the second enlarged flange portion, a recessed annular groove configured to engage an inner periphery of the water inlet opening when the single-part resilient body is positioned within the fixture wall;
wherein the single-part resilient body is formed from an elastomeric material that is deformable under compression;
wherein the elastomeric material comprises a Durometer shore A hardness of between about 40 and about 90;
wherein the single-part resilient body is formed from a molded synthetic rubber;
wherein the single-part resilient body further comprises
a longitudinal axis extending between the first end and a second end, and
the internal passage, the first enlarged flange portion, and the second enlarged flange portion are arranged symmetrically about the longitudinal axis;
wherein the first enlarged flange portion further comprises a generally frustoconical shape of circular right section arranged symmetrically with respect to the longitudinal axis;
wherein the second enlarged flange portion comprises
a generally frustoconical shape of circular right section arranged symmetrically with respect to the longitudinal axis,
a base portion located adjacent the recessed annular groove and concentric with the longitudinal axis, and
a sidewall projecting outward from the base portion and tapering to a distal circumferential edge concentric with the longitudinal axis, the distal circumferential edge having a smoothly rounded geometry;
wherein the first enlarged flange portion is configured to resiliently deform during passage through the water inlet opening and restore to a pre-deformed geometry to engage the inner surface of the fixture wall after such passage;
wherein the water supply pipe is retained within the internal passage by friction fit;
wherein the internal passage comprises a cylindrical bore adapted to receive a water supply pipe having an outer diameter between about ¾ inch and about 2 inches;
wherein the water-tight seals are formed by elastomeric compression at the mating surfaces;
wherein the pipe coupling device can be installed in toilet bowl fixture without the use of tools; and
wherein the pipe coupling device the pipe coupling device can be removed from the toilet bowl fixture without the use of tools.

18. The toilet fixture system of claim 17, further comprising set of instructions; and
wherein the device is arranged as a kit.

19. A toilet fixture method, the method comprising the steps of:
identifying a commercially-available toilet bowl fixture, the toilet bowl fixture having fixture wall containing a water inlet opening;
measuring the physical geometry of the fixture wall and the water inlet opening;
using the measured physical geometry of the fixture wall and the water inlet opening to produce a pipe coupling device to removably engage the water inlet opening, the pipe coupling device comprising a single-part resilient body including
an internal passage extending between a first end and a second end of the resilient body, the internal passage configured to receive an end portion of a water supply pipe and form a water-tight seal by compressive engagement therewith,
a first enlarged flange portion circumferentially surrounding the first end, the first enlarged flange portion configured to pass through the water inlet opening and form a water-tight seal with an inner surface of the fixture wall around the water inlet opening,
a second enlarged flange portion circumferentially surrounding the second end, the second enlarged flange portion configured to form a water-tight seal with an outer surface of the fixture wall around the water inlet opening, and
disposed between the first enlarged flange portion and the second enlarged flange portion, a recessed annular groove configured to engage an inner periphery of the water inlet opening when the single-part resilient body is positioned within the fixture wall; and
installing pipe coupling device within the water inlet opening.

20. The method of claim 19, further comprising the steps of
producing an additional stock of pipe coupling devices; and
offering the additional stock of pipe coupling devices for commercial sale as replacement parts.
